(19) United States
(12) Patent Application Publication
(10) Pub. No.: US 2010/0308578 A1
(43) Pub. Date: Dec. 9, 2010

(54) Pipe Coupling with Multi-combed Self-pressurizing Seals

(76) Inventors: Michael J Skellern, Irvine, CA (US); Keith Wyness, Neston (GB); Richard Ollerhead, Thorton Hough (GB)

Correspondence Address: Michael Skellern, 3400 Via Oporto, Suite 104, Newport Beach, CA, 92663, US

(21) Appl. No.: 12/749,513

(22) Filed: Mar. 30, 2010

Related U.S. Application Data
(60) Provisional application No. 61/183,633, filed on Jun. 3, 2009.

(51) Int. Cl. F16L 17/06; F16J 15/02

(52) U.S. Cl. 285/379; 277/605

(57) ABSTRACT

This invention relates to pipe coupling with multi-combed, self-pressurizing internal seals and an integral pipe fastening system to join and seal pipes of all sizes, fluid contents and line pressures. The invention embodies a coupling body, two pressure responsive seals installed in recessed seal grooves located at opposite outside edges of the pipe coupling body, and seal body consisting of a unidirectional fluid inlet and internal pressure responsive chamber and an external sealing surface comprised of several resilient, multi-combed and conjoined lips and fluid pockets which form a series of redundant seals around the outside axial surface of pipes joined within the coupling. Fluid escaping from the pipe juncture enters the internal pressure responsive chamber through the unidirectional orifice wherein trapped fluids expand the pliable external multi-combed seal surface against the axial surface of each pipe with corresponding force to prevent the outward flow of fluid from the pipe coupling.

### RELATED U.S. APPLICATION DATA

Provisional application No. 61/183,633, filed on Jun. 3, 2009

### STATEMENT OF FEDERALLY SPONSORED RESEARCH/DEVELOPMENT

Not Applicable.

### FIELD AND BACKGROUND OF THE INVENTION

This invention relates to the field of joining of pipes in the oil and gas industry, pipeline construction, maritime, ship building, plumbing, air conditioning, food processing and other related industries. The field of joining of pipes has seen relatively few advances in the connection of pipes in relative terms of improved performance, leak prevention, and cost and time to complete the joining of pipes and to prevent fluid leakage. Prior devices and methods to join pipes have limitations in terms of installation time, seal performance, and costs which are directly related to pipe size, pipe material, fluid contents, line pressure, environment, equipment and required labor skills, installation time, and joint testing. This invention obviates the limitations of prior devices and methods to join pipes of different sizes, fluid contents and line pressures in all industries with faster and safer installation, improved joint integrity and longevity against corrosion and leaks at lower costs.

### OBJECT OF THE INVENTION

The object of this pipe coupling invention with internal multi-combed self-pressurizing seals and integral pipe fastening system is to obviate the disadvantages of other devices and methods currently used to join pipes in all industries, and to provide a device and method to join pipes of all sizes, fluid contents, and line pressures with improved ease and speed of installation, improved join integrity and longevity, prevent fluid leakage under line pressure, reduce safety and environmental hazards, and lower installation costs to join pipes and overall costs of pipeline system costs.

### BRIEF SUMMARY OF THE INVENTION

This self-sealing pipe coupling embodies internal self-pressurizing seals and an integral pipe fastening system that replaces welding, compression clamps, bolted flange assemblies, and other devices and methods to join pipes of all sizes, fluid contents, and line pressures with improved ease and speed of installation, improved join integrity and seal longevity, reduces safety and environmental hazards, prevents fluid leakage under line pressure, and lower costs to join pipes and overall pipeline system costs. Two (2) self-pressurizing seals are installed in recessed seal grooves located at opposite outside edges of the pipe coupling body and as each pipe section is inserted into the coupling the pliable sealing surface comprising multiple combed and conjoined fingers fold upwardly and inwardly to protect the sealing surface from damage. The seal, which is manufactured of non-corrosive and fire-resistant materials, embodies a unidirectional fluid orifice that directs escaping fluid into an internal pressure responsive chamber wherein trapped fluid causes outward expansion of the external sealing surface which is comprised of multiple combed and conjoined fingers which form a series of redundant pliable seals to oppose the outward flow of fluids from the pipe juncture with correspondingly greater force.

Technical Problem

Welding is currently used to join larger pipe sizes, generally 10.1 cm or larger diameter pipes which exceed 152.4 cm” in diameter. The welding process is labor intensive, time consuming and is hazardous to personnel and the environment. The welding process requires specialist equipment and skilled labor, and contributes to almost half the average cost of total pipeline construction and represents a substantial cost to join pipes in all other industries. Installation time and costs to join pipes escalates according to the installation environment, size of pipes to be joined, setup time required prior to welding, pipeline fluid contents and line pressure.

Welding requires non-destructive testing to examine the welding seam for pin holes inherent in the welding process, which is time consuming, labor intensive and costly. Fluid system tests are typically conducted between pumping stations which leaves pipelines exposed to damage, sabotage, and piracy.

The welding process leads to eventual joint corrosion and leaks due to exterior and interior corrosion at the welded pipe join seam. The welding process burns away the protective coating of the pipe end. Interior corrosion of pipe joins can be caused by exposed metal to tiny pinholes in the seam, corrosive fluid contents such as heavy crude oil and certain gases, which leads to eventual fluid leakage and environmental damage, costly repair and restoration. Repair of leaking or damaged pipes requires system shut-down, degassing, cutting, and welded replacement of pipe sections which is a time consuming, labor intensive, dangerous, and expensive process.

The joining pipes using compression devices and seals with ‘O’ rings or compression sleeves is limited to smaller sizes and lower line pressures. These seals are prone to damage and dislodgement during pipe insertion, movement during the compression process, and “O” ring seal tend to move axially around the pipe surface in outward direction as line pressure increases.

Bolted flange assemblies used to join pipes are relatively heavy, require additional space and structural support, and require more labor and equipment to install which increases costs and extends time to completion of installation. In the ship construction bolted flange pipe connections add several thousand tons to completed vessel displacement thereby reducing cargo capacity, fuel consumption, and increasing costs of vessel operation.

Solution to Problem

This pipe coupling invention with internal self-pressurizing seals and integral pipe fastening system obviates the disadvantages, limitations and costs of other welded and non-welded methods to join pipes of all sizes, fluid contents and line pressures. The pipe coupling embodies two (2) recessed seal grooves located at the opposite outer edges of the coupling body in which the resilient non-corrosive and fire resistant self-pressurizing seal is installed, an internal pressure responsive chamber and pliable sealing surface of multiple, pliable and conjoined ridges that form a series of redundant circumferential seals around the circumferential surface of pipe to stop the outward flow of fluids from the pipe juncture in the coupling under pressures in excess of 600 BAR.

This pipe coupling invention with internal self-pressurizing seals and integral pipe fastening system does not require pre-welding setup thereby eliminating costly set-up, equipment and labor costs.

This pipe coupling invention with internal self-pressurizing seals and integral pipe fastening system does not require non-destructive testing and an open trench, as pipe connections using this coupling can be tested immediately after pipe connection in the coupling, thereby eliminating excessive equipment, labor, time and costs and provides for immediate trench back-fill to lower the risk of damage, sabotage, or piracy.

Advantageous Effects of Invention

This pipe coupling invention with internal self-pressurizing seals and integral pipe fastening system provides significant advantages in terms of installation speed, sealing performance, installation costs, and overall time and costs of completed pipeline systems of all pipe sizes, fluid contents, and line pressures, including above ground, below ground, or undersea installations, by replacing the slow, labor intensive and costly welding process to join large pipes ranging in size from 10.16 cm to more than 152.4 cm in diameter, and to replace welding, brazing, leading, adhesives, compounds, liquids, and external clamping and internal compression devices used to join smaller diameter pipes in other industries. This self-pressurizing seal provides significantly faster installation, lowers safety and environmental hazard risks, at substantially lower costs than prior devices and methods.

This pipe coupling with its internal multi-combed self-pressurizing seals and integral fastening system has been tested by government sanctioned testing facilities to pressures that exceed 8,702 PSI or 600 BAR.

### DESCRIPTION OF THE DRAWINGS

The invention is described in further detail with reference to the drawings which represent the embodiments of the invention. Structural details are illustrated only for fundamental understanding of the invention.

### Described in the Drawings:

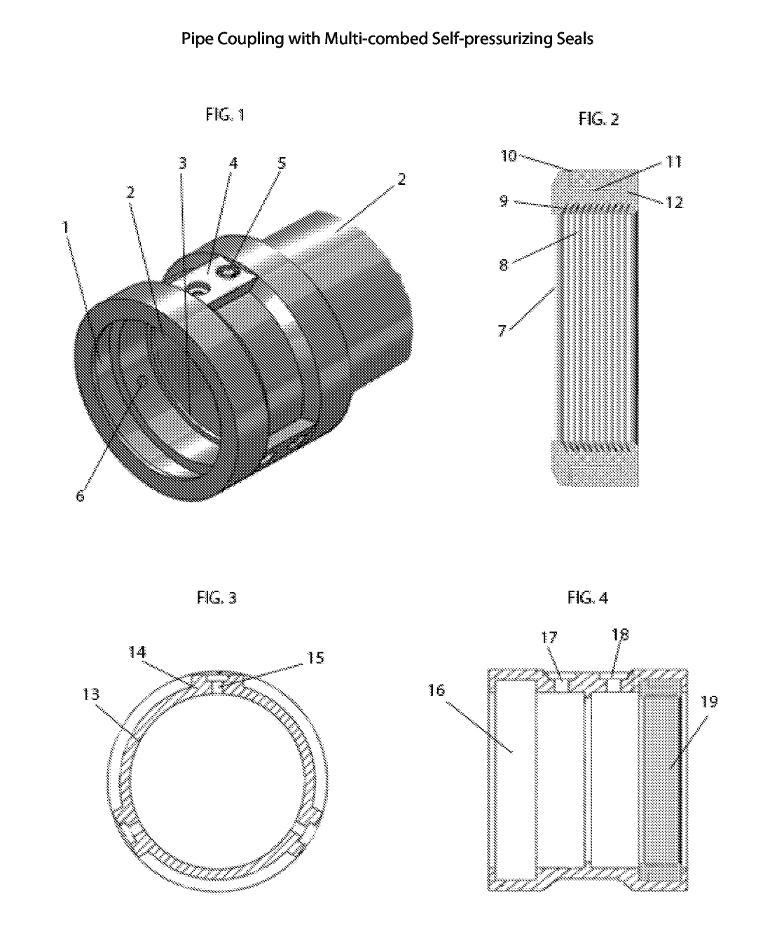

FIG. 1 Horizontal three-dimensional view of the pipe coupling invention illustrating; a) an internal view of the pipe stop located in center of the coupling; b) an internal view of one of two recessed seal grooves located at each opposite outside edge of the coupling; c) an internal view of one integral fastener opening; d) a an external view of the one (1) of three (3) integral fastening system blocks located at the top of the coupling; e) one (1) of three (3) integral fastener blocks located at the lower right side of the coupling; f) a partial pipe section installed in the pipe coupling extending outwardly from the internal pipe stop.

FIG. 2 Vertical cross-sectional view of the self-pressurizing seal illustrating; a) an external sealing surface consisting of multiple, pliable, conjoined seal ridges and reservoirs; b) an internal pressure responsive chamber located in the seal body; c) a inlet orifice leading to the internal pressure responsive chamber located at the top inside edge; and, d) tapered outside edge of the seal.

FIG. 3 Horizontal cross-sectional end-view of the pipe coupling illustrating the location of three (3) equidistant fastener system blocks with recessed bolt housings used to secure opposing pipe sections within the coupling body.

FIG. 4 Horizontal cross-sectional side-view of the pipe coupling illustrating; a) a recessed seal groove located on the left outside edge of the coupling; b) a recessed seal groove with self-pressurizing seal installed in seal groove located at the right outside edge of the coupling; c) one of three fastener housings with two of six recessed bolt housings shown at the top of the coupling; and, d) opposite side perspective drawings indicated by dashes illustrating two (2) of three (3) fastener housings illustrating four (4) of six (6) recessed bolt housings in the lower center section of the coupling.

### DETAILED DESCRIPTION OF THE INVENTION

The invention will now be described in further detail to the accompanying drawings, which represent by example embodiments of the invention. Structural details are shown only as far as necessary for a fundamental understand thereof. The described example, together with the accompanying drawings, will make apparent to those skilled in the art and field how further forms of the invention may be realized.

### Described in the Drawings:

The pipe coupling body manufactured of either ferrous or non-ferrous material and consists of three (3) integral fastening blocks with three (3) high tensile bolts and seals which secure each opposite pipe section within the pipe coupling. The inventions two (2) self-pressurizing seals are installed in recessed seal grooves located at opposite outside edges of the pipe coupling body. The seal is manufactured of non-corrosive and fire-resistant materials and embodies a unidirectional fluid orifice that directs escaping fluid into an internal pressure responsive chamber wherein the trapped fluid causes outward expansion of the external sealing surface, comprised of multiple combed and conjoined fingers and fluid pockets which form a series of redundant pliable seals to oppose the outward flow of fluids from the pipe juncture with correspondingly greater force.

In FIG. 1 there is seen the pipe coupling body with one of two internal recessed seal grooves 1 extending circumferentially around the inside opposite edges of the pipe coupling wherein each self-pressurizing seal is installed. The pipe 2 is inserted into opposite sides of the pipe coupling until reaching to the pipe stop 3 extending circumferentially around the inside centerline of the pipe coupling body. Each pipe section is secured within the pipe coupling body using the integral fastening system 4 housing wherein three (3) fastening bolts 5 for each opposite pipe are inserted through the pipe coupling body 6 from the external fastener housing 4 which is located at three (3) equidistant locations around the outside of the coupling body as seen in the horizontal cross-section end view of the coupling as seen in FIG. 3.

In FIG. 2 illustrates a vertical cross-section of the circumferential self-pressurizing seal with left side 7 which is installed facing inward to toward the center of the pipe coupling or valve body. The sealing surface embodies multiple and conjoined pliable ridges 8 and fluid reservoirs 9 which form a series of redundant seals against the axial surface of a pipe inserted and secured within the pipe coupling. As each pipe section is inserted into the pipe coupling the multiple, conjoined and pliable ridges 8 are compressed inwardly toward pipe juncture which protects the self-pressurizing seal from damage or dislodgement during insertion of the pipe into the coupling. Fluid escaping under pressure from the pipe juncture within the pipe coupling migrates along the axial pipe surface until the fluid is blocked by inside edge of the seal 7, and residual fluid under pressure is forced into the pipe coupling's recessed seal groove and into the unidirectional inlet orifice 10 and into the internal pressure responsive chamber 11 whereby trapped fluid under pressure expands outwardly to force external seal surface 8 of multiple conjoined seals against the axial surface of the pipe with increasing force pressure to prevent the outward flow of fluids. This same outward expansion of the internal pressure responsive chamber 11 simultaneously expands the seal body within the recessed seal groove to prevent dislodgement or leakage from the pipe coupling. The self-pressurizing seal body 12 is manufactured of resilient natural and synthetic materials which are specifically formulated to resist the corrosive elements of certain fluids and contain a fire retardant to prevent seal failure in the case extreme temperatures. Seals are color-coded according to identify specific seal material for appropriate pipe fluid contents and temperature requirements.

FIG. 3 illustrates a horizontal cross-section end view of the coupling body and interior axial surface of the pipe coupling body 13, and the location of the integral fastening system 14 housing and fastening bolts 15 located equidistantly around the circumference of the pipe coupling provide uniform pressure around the axial surface of each pipe to secure the pipe within the pipe coupling without pipe deformation.

FIG. 4 illustrates a horizontal cross-section side view of the pipe coupling showing an empty recessed seal groove 16 located on the left outside edge of the pipe coupling, a recessed fastening bolt 17 to secure a pipe section within the left side of the pipe coupling, and a recessed fastening bolt 18 to secure a pipe section within the right side of the pipe coupling. A cross-section view of the self-pressurizing seal 19 is shown installed in the recessed seal groove on the right outside edge of the pipe coupling.

1. A pipe coupling body embodying an integral pipe fastening system incorporating three (3) fastener housings located equidistantly around the outside of the pipe coupling body which facilitate three (3) fastening bolts which uniformly secure each opposite pipe section within the pipe coupling to prevent pipe distortion, and two (2) recessed seal grooves located at the outside opposite edge of the pipe coupling body into which the circumferential multi-combed self-pressurizing seal is installed to prevent the outward flow of fluids from the pipe coupling.

2. A multi-combed self-pressurizing and self-sealing seal embodying a unidirectional fluid orifice to capture and direct escaping fluid from the juncture of pipes within the pipe coupling into an internal pressure responsive chamber, wherein the fluid entering and trapped in the internal chamber causes outward expansion of the external sealing surface, comprised of multiple, combed and conjoined fingers and fluid pockets which form a series of redundant pliable seals to oppose the outward flow of fluids from the pipe juncture with correspondingly greater force.

3. A pliable multi-combed self-pressuring seal produced of resilient corrosion resistant and flame retardant materials to resist corrosive fluid elements and excessive temperatures to present seal degradation and failure.
